(19) United States
(12) Patent Application Publication
(10) Pub. No.: US 2014/0175144 A1
(43) Pub. Date: Jun. 26, 2014

(54) HAND-OPERATED COIL STAPLER

(71) Applicant: PATEK PNEUMATICS CO., LTD., New Taipei City (TW)

(72) Inventor: Hsien Cheng CHEN, New Taipei City (TW)

(73) Assignee: PATEK PNEUMATICS CO., LTD., New Taipei City (TW)

(21) Appl. No.: 14/061,252

(22) Filed: Oct. 23, 2013

(30) Foreign Application Priority Data
Dec. 21, 2012 (TW) 101224773

(51) Int. Cl. B25C 5/08

(52) U.S. Cl. CPC B25C 5/08
USPC 227/87

(57) ABSTRACT

A hand-operated coil stapler includes a main body having a linkage system provided therein; a staple driving mechanism assembled to a front end of the main body and including a complex staple driver; a pusher and magazine assembly connected to a bottom of the main body and including a push rod having a staple-pushing spring fitted therearound; and a coil staple unit formed of bar-shaped staples. When the main body is downward pushed, the linkage system brings the complex staple driver to bend and drive a first staple of the coil staple unit into a workpiece. Meanwhile, the complex staple driver comes into contact with the push rod and forces the latter backward to compress the staple-pushing spring. When the main body is released, the staple-pushing spring elastically moves the push rod forward, bringing a subsequent staple to a position below the complex staple driver for a next stapling operation.

### FIELD OF THE INVENTION

The present invention relates to a hand-operated coil stapler that is used with a coil staple unit having a large quantity of bar-shaped staples, and more particularly, to a hand-operated coil stapler that bends a first bar-shaped staple on the coil staple unit and drives the bent staple into a workpiece at the same time.

### BACKGROUND OF THE INVENTION

Generally, to use a hand-operated hammer tacker, the hammer tacker is directly pushed to knock against a workpiece, so that a U-shaped staple is driven by a driver into the workpiece to complete one stapling operation. When the hammer tacker is released from the push, an elastic element inside the hammer tacker elastically returns the latter to an original position ready for a next stapling operation.

FIG. 1 shows a conventional hand-operated non-linkage hammer tacker that is very common in the market. This type of hammer tacker includes a main body 10, a magazine assembly 11, a pusher assembly 12, and a handle grip 13. The main body 10, the magazine assembly 11 and the handle grip 13 are pivotally connected together at their rear ends. A leaf spring 101 is provided in the main body 10 for providing an elastic restoring force after one stapling operation. A balancing piece 102 and a driver 103 is sequentially riveted to a front end of the main body 10. The magazine assembly 11 has a long strip of U-shaped staples mounted therein, and is assembled in the main body 10 corresponding to the driver 103, so that a first one of the strip of U-shaped staples that is pushed to a position below the driver 103 can be driven by the driver 103 into a workpiece. Meanwhile, a push guide 121, a push rod 122 and a rear cover 123 are sequentially located in the magazine assembly 11 behind the U-shaped staples. An adjustable spring 124 is fitted around the push rod 122 to provide a tension force against the push guide 121, so that the U-shaped staples are always pushed forward by the push guide 121 to be driven by the driver 103 in a next stapling operation.

FIG. 2 shows a conventional hand-operated linkage built-in hammer tacker, which includes a main body 20, a magazine assembly 21 received in the main body 20, a pusher assembly 22 and a handle grip 23. The magazine assembly 21 and the main body 20 are screwed together at their rear ends. A linkage mechanism 201 is provided inside the main body 20 to provide an elastic restoring force after one stapling operation. The linkage mechanism 201 is connected to a driver 202, so that the driver 202 can always be elastically returned to its original position from the downward and upward movement of driving the staple into a workpiece. The pusher assembly 22 is located in the magazine assembly 21 and sequentially includes a push guide 221, a long push rod 222 and a back cover 223. An adjustable spring 224 is fitted around the long push rod 222 to provide a tension force against the push guide 221, so that U-shaped staples inside the magazine assembly 21 are always pushed forward by the push guide 221 for the first staple to locate below the driver 202. In this manner, the U-shaped staples can be continuously driven by the driver 202 into the workpiece.

In addition to the above described hand-operated non-linkage and linkage built-in hammer tackers, there are still other types of hand-operated staple guns available in the market. A conventional hand-operated staple gun usually includes a handle grip for pushing by a user, and an extension spring and a plate spring for continuously generating a spring force and a restoring force. The handle grip works with the extension spring and the plate spring to achieve the purpose of transmitting force, so that a driver can fix and drive a staple into a workpiece.

FIG. 3 shows a conventional hand-operated staple gun, which includes a main body 30, a driver 31, a pusher assembly 32, and a handle grip 33. The pusher assembly 32 is mounted in the main body 30 to locate at lower portion thereof. Through the operating principle mentioned in the above paragraph, U-shaped staples are pushed forward by the pusher assembly 32 for the first staple to locate below the driver 31. The handle grip 33 is pivotally connected to the main body 30 with a shaft pin 331. Through the spring force and the restoring force generated by an extension spring 301 and a plate spring 302, a push force applied to the handle grip 33 is transmitted to the driver 31, so that the driver 31 is upward pulled to fix and drive the first U-shaped staple below it into a workpiece. After the stapling operation, the handle grip 33 and the driver 31 are directly returned to their original positions and ready for a next stapling operation.

Either the conventional hand-operated hammer tackers or the conventional staple guns are limited to use with U-shaped staples. This is because these hammer tackers and staple guns can only perform the simple movement of driving the staples into a workpiece, and accordingly, the staples must be bent into a U shape before they can be used with the conventional hammer tackers and staple guns to complete the stapling operation. However, being limited by the shape thereof, the U-shaped staples are usually supplied in the form of a long strip, which must be stored in a U-shaped long magazine. In the event the U-shaped magazine is short in length, it can only hold a limited quantity of staples. On the other hand, in the event the U-shaped magazine is quite long for holding more staples, the hammer tackers and the staple guns must also have an extended main body to receive the long magazine, making the hammer tackers and the staple guns inconvenient for use.

Other problems with the conventional hammer tackers and staple guns include dry fire and jammed staples. The driver is subject to damage due to too many times of dry fire, and the damaged driver tends to expand the width of a staple outlet on the magazine. Further, when there are only one or two staples left in the magazine, the driver tends to be stuck in the staple outlet due to a reaction applied thereto by the last staple. The stuck driver will cause jammed staples because the hammer tacker or the staple gun with the stuck driver is prevented from returning to the original position for a next stapling operation.

In conclusion, the conventional hammer tackers and staple guns are not able to hold a large quantity of staples at one time and tend to have the problems of dry fire and jammed staples. With these problems, the conventional hammer tackers and staple guns are prevented from operating normally and require repair or adjustment. And, the conventional hammer tackers and staple guns need to be frequently recharged with staples, which is time and labor consuming.

In view of the above disadvantages, it is tried by the inventor to develop an improved hand-operated coil stapler that is used with a coil staple unit capable of supplying a large quantity of bar-shaped staples at one time, and can therefore operate with lowered possibility of dry fire and jammed staples to advantageously increase the service life and working efficiency of the coil stapler.

### SUMMARY OF THE INVENTION

A primary object of the present invention is to provide a hand-operated coil stapler, which is used with a coil staple unit capable of supplying a large quantity of bar-shaped staples at one time and includes a complex staple driver actuated by a linkage system to achieve the function of bending a bar-shaped staple and driving the bent staple into a workpiece at the same time, making the stapling operation more efficient.

Another object of the present invention is to provide a hand-operated coil stapler having an improved pusher and magazine assembly for accommodating a coil staple unit capable of supplying a large quantity of bar-shaped staples at one time, so that the possibility of jammed staples or dry fire in the course of stapling operation is reduced to enable extended service life of the coil stapler.

To achieve the above and other objects, the hand-operated coil stapler according to the present invention includes a main body, a staple driving mechanism, a pusher and magazine assembly, and a coil staple unit. The main body includes a case, in which an operation room is defined; and a linkage system is arranged in the operation room and pivotally connected to the case. The staple driving mechanism is assembled to a head portion at a front end of the main body, and includes a pressing member and a complex staple driver. The pressing member is movably assembled to an outer side of the case to engage with the linkage system; and the complex staple driver is also engaged with the linkage system and includes a driving plate for driving a bent staple into a workpiece and a bending plate for bending a bar-shaped staple into an inverted-U shape. The pusher and magazine assembly is connected to a bottom of the main body, so that the pusher and magazine assembly and the main body together define a staple room in between them. The pusher and magazine assembly includes a magazine and a movable pusher mechanism mounted in the magazine. The pusher mechanism includes a push rod, a push plate fixedly connected to a front end of the push rod with a locking pin, and a staple-pushing spring fitted around another end of the push rod. The coil staple unit includes a plurality of bar-shaped staples, which are parallelly arranged and continuously connected to form a web for winding into a coil. The coil staple unit is mounted in the staple room with a front end thereof located below the complex staple driver.

When the main body is downward pushed relative to the pressing member, the linkage system brings the complex staple driver to downward push against the staple at the front end of the coil staple unit, so as to bend and drive the staple downward. Meanwhile, the downward pushed complex staple driver comes into contact with the push rod, forcing the same backward and thereby compressing the staple-pushing spring. When the main body is released, the complex staple driver is moved upward to separate from the push rod, and the staple-pushing spring is released from the compressed state to thereby elastically move the push plate and the push rod forward, which in turn forward move a subsequent staple on the coil staple unit to the position below the complex staple driver for use in a next stapling operation.

According to a preferred embodiment of the present invention, the case includes an enclosure, a shaped top cover riveted to a top opening of the enclosure, and an inner cover riveted to a front opening of the enclosure. The inner cover is provided with two laterally spaced first vertical slots, a second vertical slot located below the first vertical slots, and two laterally spaced insertion slots. The pressing member is provided with a first opening at a position corresponding to the first vertical slots on the inner cover; the complex staple driver is provided with second openings at a position corresponding to the second vertical slots on the inner cover; and the complex staple driver is engaged with the linkage system via the second openings.

An outer cover is further provided to locate at an outer side of the inner cover. The outer cover includes two laterally spaced connection arms correspondingly inserted into the two insertion slots on the inner cover, so that the outer cover and the inner cover can be together riveted to the enclosure with a first screw rod while the connection arms of the outer cover are further riveted to the enclosure with a second screw rod. The pressing member is located between the outer cover and the inner cover. The outer cover is provided with two laterally spaced third vertical slots corresponding to the first vertical slots, and is engaged with the linkage system via the third vertical slots, the first opening on the pressing member and the first vertical slots on the inner cover.

The linkage system includes a follower unit, a compression spring fitted on the follower unit, and two driving links located at two outer sides of the follower unit. Each of the driving links has a nose portion projected from a front end thereof to sequentially engage with the first vertical slot, the first opening and the third vertical slot, and is provided with a first pivot hole and a second pivot hole. The first screw rod is extended through the first pivot hole. The follower unit is provided on an upper edge with a notch corresponding to the first screw rod, at a lower front end with a forward projected portion corresponding to the second openings and the second vertical slot, at a rear end with an upward raised portion, on which an end of the compression spring is fitted, and within a middle section with a third pivot hole and a fourth pivot hole. A bare shaft is extended through the second pivot holes on the driving links and the third pivot hole on the follower unit, such that the driving links and the follower unit are pivotally turnable relative to one another; and a third screw rod is extended through the fourth pivot hole, so that the follower unit is pivotally connected to the enclosure. The shaped top cover is provided with a flat pin, on which another end of the compression spring is fitted.

According to a preferred embodiment of the present invention, the magazine includes a base board, a push block and a bottom cover. The bottom cover is riveted to the case with a shaft pin; the base board and the push block are connected to each other and screwed to the bottom cover together; and the base board is provided with a vertically upward extended projection having a horizontally axially extended passage for the push rod to extend therethrough. The staple-pushing spring has a rear end pressed against the push block, so as to bring the push plate and the push rod to move between the base board and the push block in a reciprocating motion.

The pusher and magazine assembly further includes a guide unit welded to the bottom cover to locate above the upward extended projection of the base board; and the guide unit includes a locating member, a spring plate and a guide plate, which are sequentially riveted together. An end of the push rod that is extended through the passage on the upward extended projection of the base board is formed into a beveled surface. The locating member is provided on one side opposite to the spring plate with two laterally spaced and forward extended arms, the spring plate has a first extended portion, and the guide plate has two second extended portions. When the locating member, the spring plate and the guide plate are riveted together, the first extended portion is located between the two second extended portions while the first extended portion and the second extended portions are together located between the two extended arms of the locating member.

The present invention is characterized in that, when using the hand-operated coil stapler to do the stapling operation, the pressing member is pressed against a position on the workpiece adjacent to the position for installing the staple. Therefore, when the main body is manually downward pushed toward the position for installing the staple, the pressing member is upward moved relative to the main body and the complex staple driver is caused to bend a first bar-shaped staple and drive the bent staple down into the workpiece at the same time. With this design, a coil staple unit supplying a large quantity of bar-shaped staples can be used with the stapler to replace the conventional U-shaped staples, so that more staples can be accommodated in the magazine to reduce the times of recharging the coil stapler and upgrade the working efficiency. In addition, with the particularly designed pusher and magazine assembly, the possibility of jammed staples in the course of the stapling operation is reduced to thereby enable extended service life of the coil stapler.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a conventional hand-operated non-linkage hammer tacker;

FIG. 2 is an exploded perspective view of a conventional hand-operated linkage built-in hammer tacker;

FIG. 3 is an exploded perspective view of a conventional hand-operated staple gun;

FIG. 4 is an assembled perspective view of a hand-operated coil stapler according to a preferred embodiment of the present invention;

FIG. 5 is an exploded perspective view showing a front outer cover, a case, a pressing member, and a complex staple driver for the coil stapler of FIG. 4;

FIG. 6 is an exploded perspective view showing a linkage system and a shaped top cover for the coil stapler of FIG. 4;

FIG. 7 is an exploded perspective view of a pusher and magazine assembly for the coil stapler of FIG. 4; and

FIGS. 8A to 8D show how the coil stapler of the present invention operates.

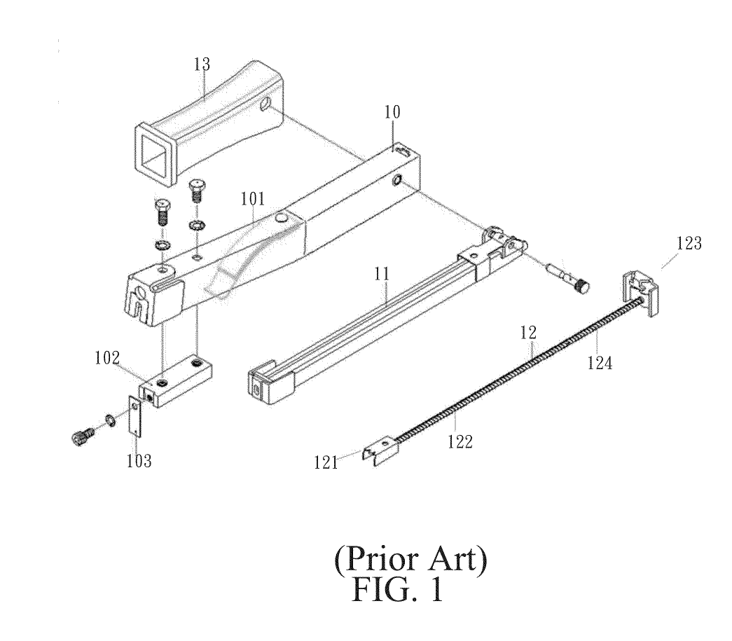

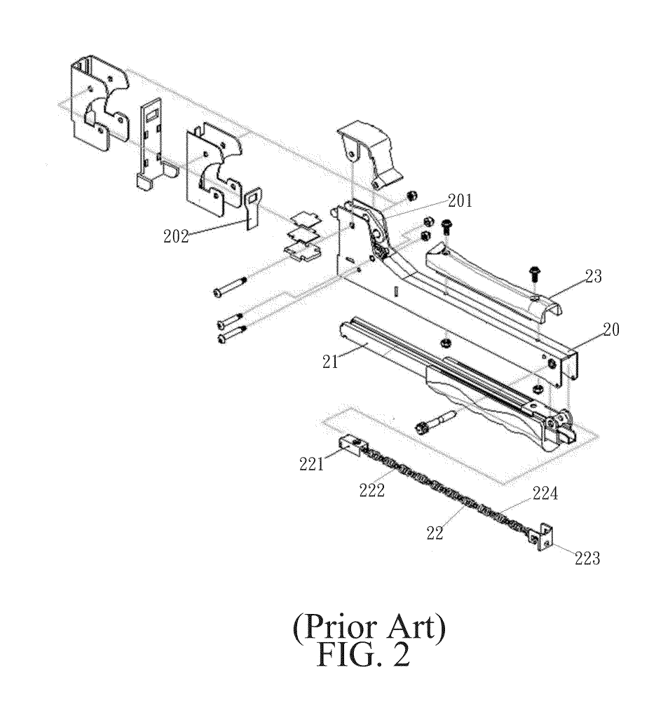

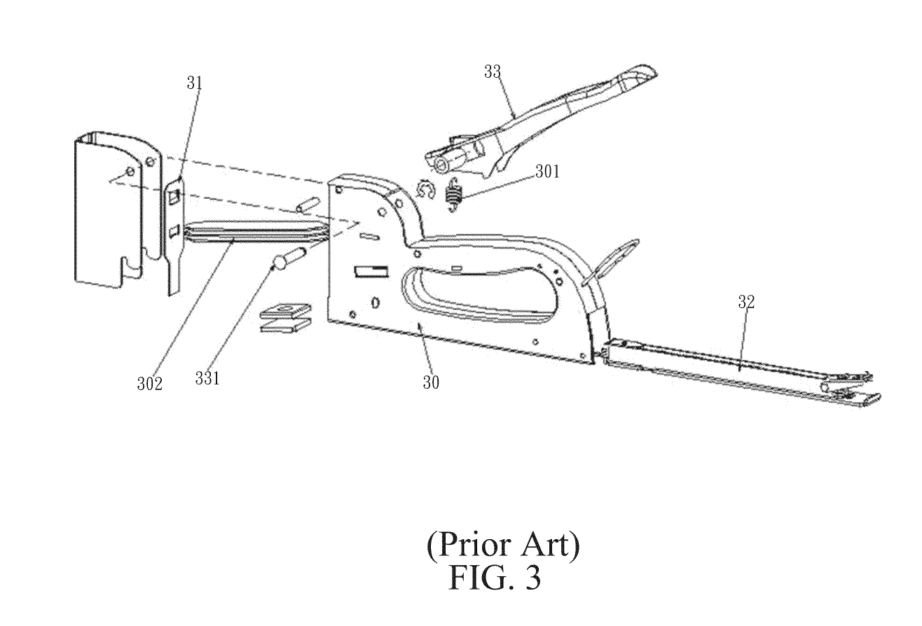

### DETAILED DESCRIPTION OF THE PREFERRED EMBODIMENTS

The present invention will now be described with a preferred embodiment thereof and with reference to the accompanying drawings.

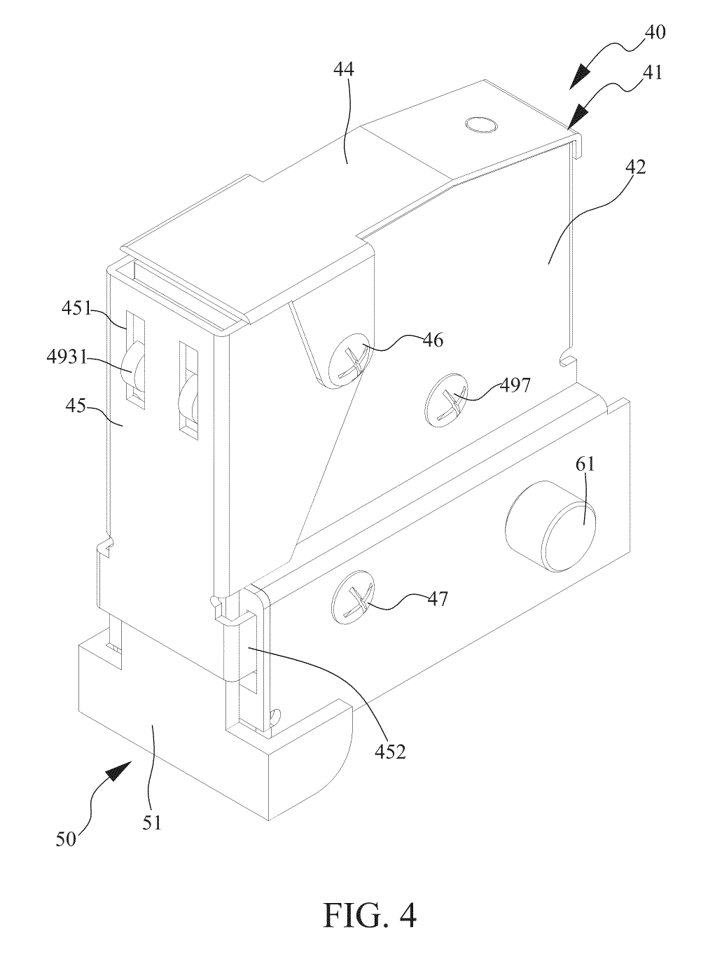

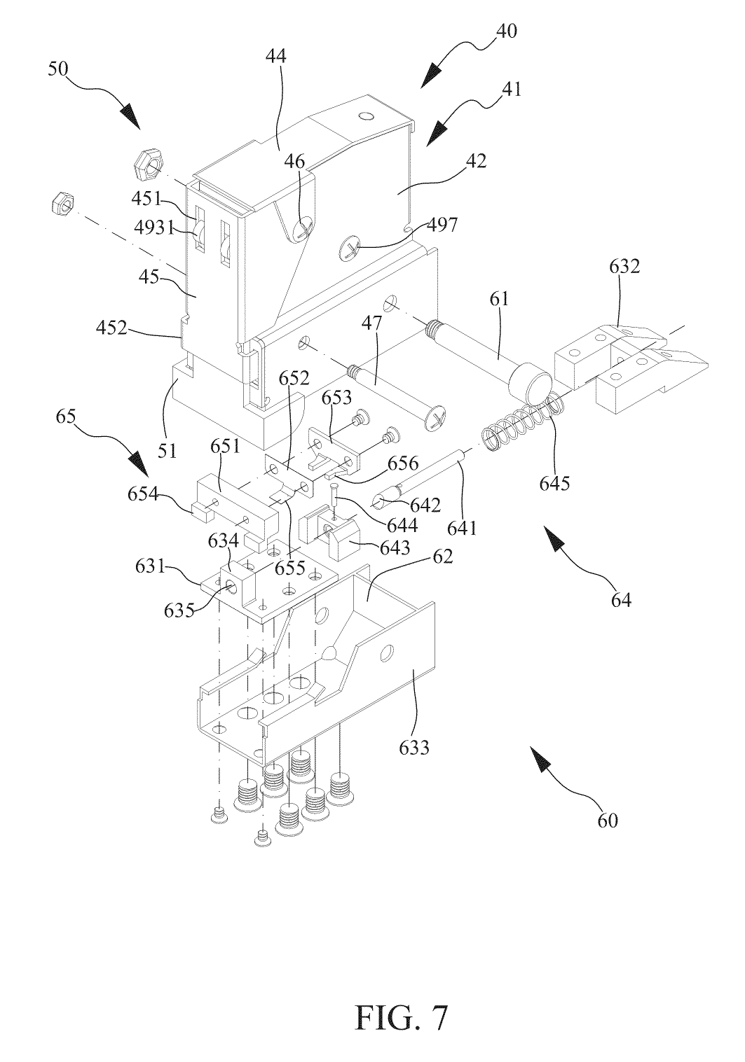

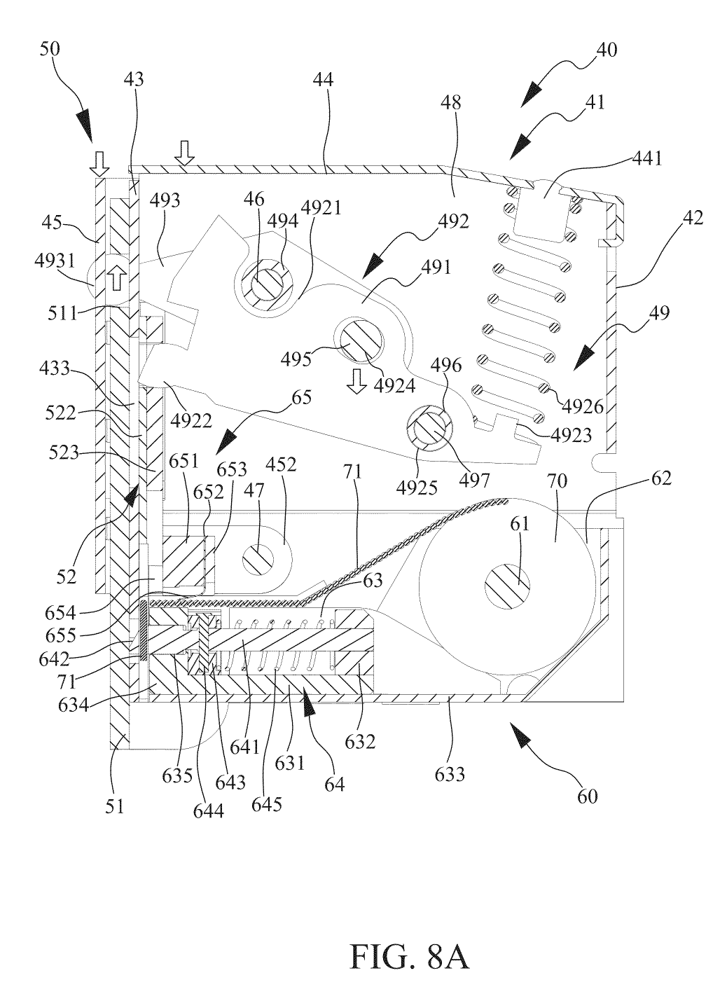

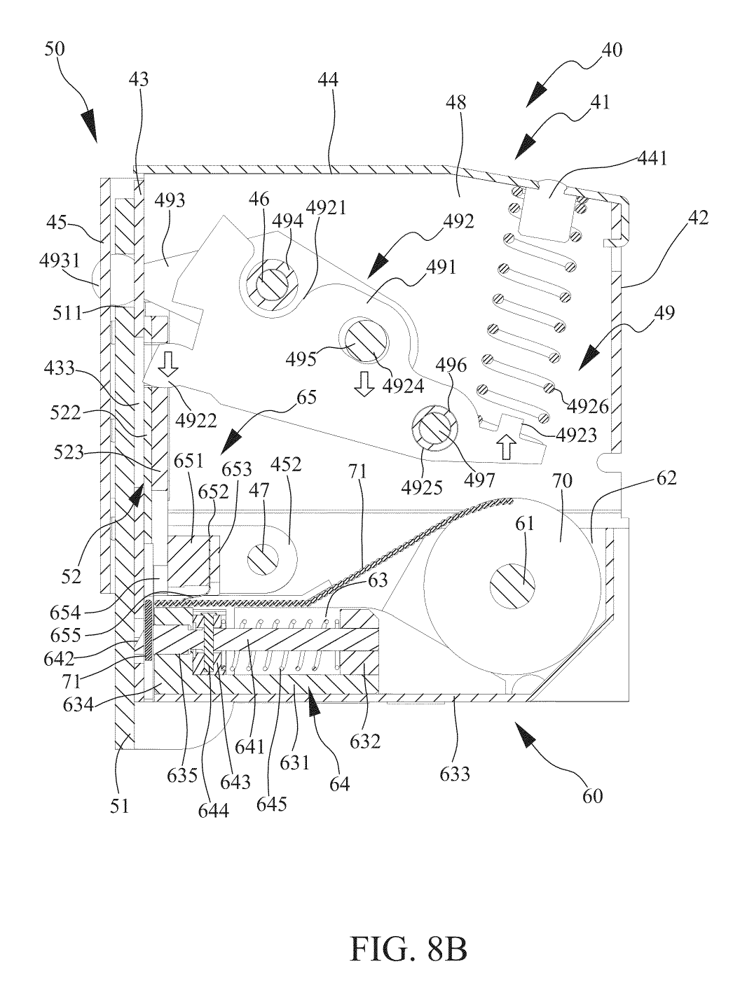

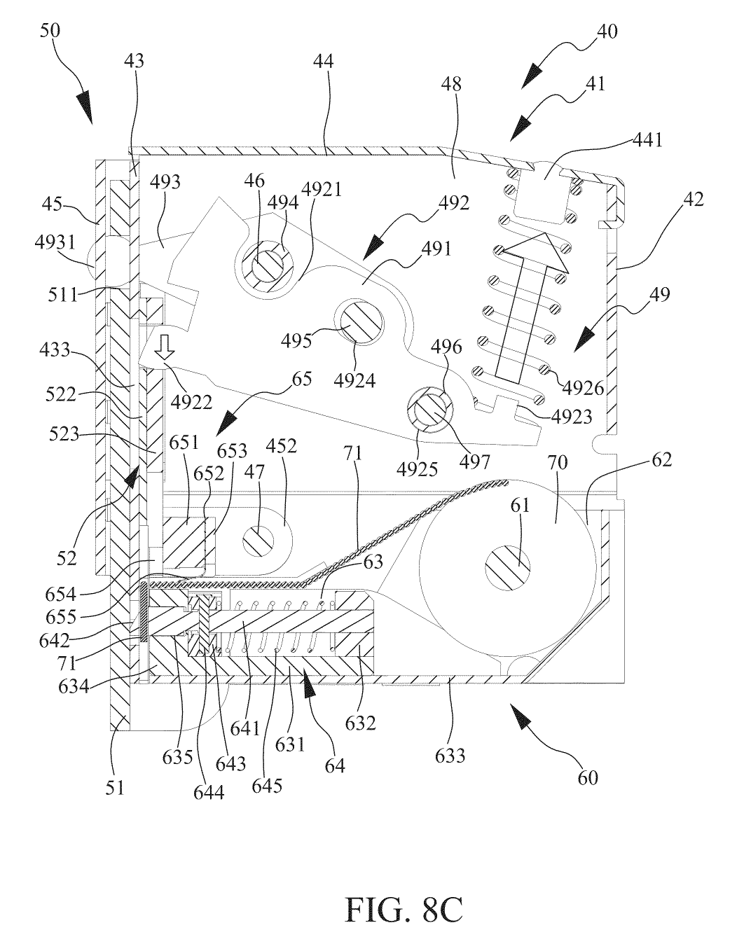

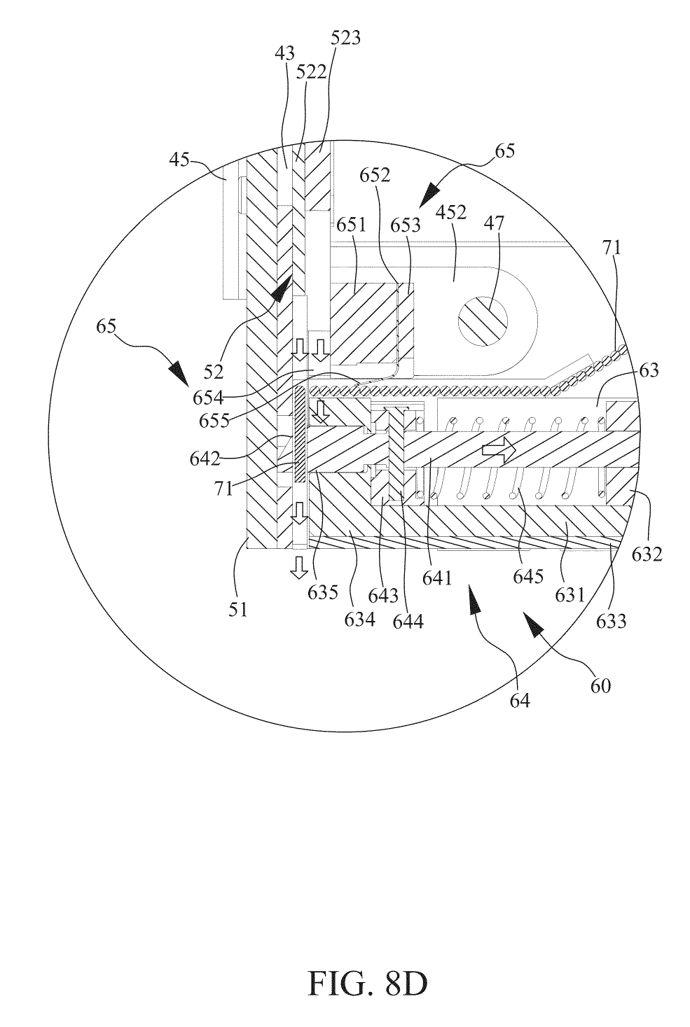

Please refer to FIG. 4, which is an assembled perspective view of a hand-operated coil stapler according to a preferred embodiment of the present invention. For the purpose of conciseness and clarity, the present invention is also briefly referred to as “the coil stapler” herein. As shown, the coil stapler includes a main body 40, a staple driving mechanism 50, a pusher and magazine assembly 60 (see FIG. 7), and a coil staple unit 70 (see FIGS. 8A-8D).

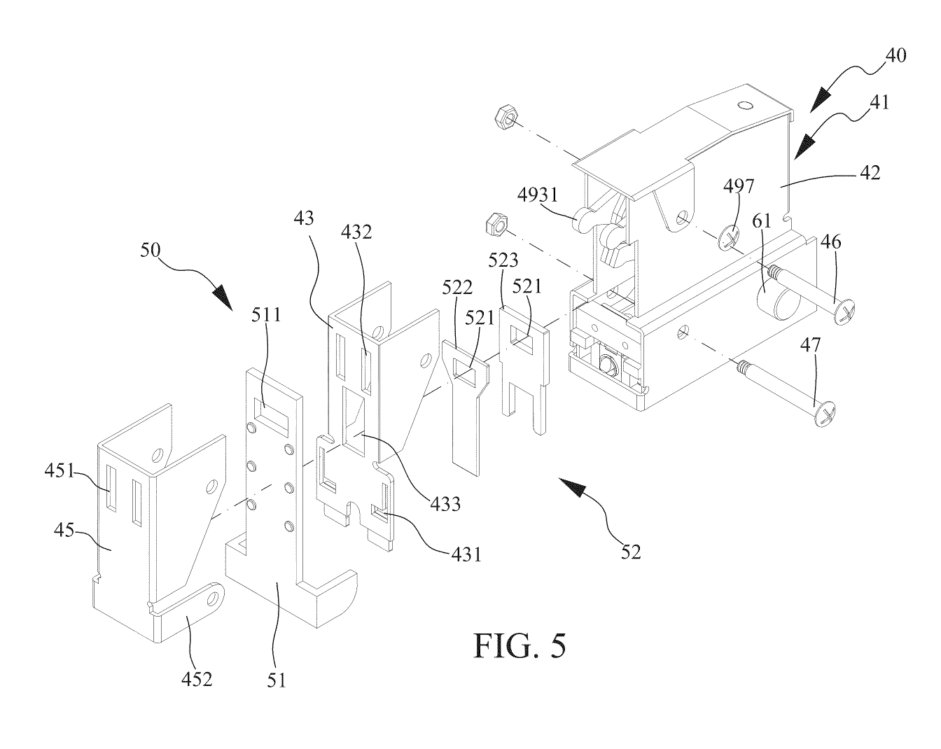

Please refer to FIG. 5. The main body 40 includes a case 41, which is assembled from an enclosure 42, an inner cover 43 riveted to a front opening of the enclosure 42, a shaped top cover 44 riveted to a top opening of the enclosure 42, and an outer cover 45 connected to an outer side of the inner cover 43. The inner cover 43 is provided near a lower portion with two laterally spaced insertion slots 431, near an upper portion with two laterally spaced first vertical slots 432, and near a middle portion with a second vertical slot 433. The outer cover 45 is provided near an upper portion with two laterally spaced third vertical slots 451, and at a lower side with two laterally spaced connection arms 452 corresponding to the two insertion slots 431. By extending the two connection arms 452 through the two insertion slots 431, the outer cover 45 can be riveted to the enclosure 42 along with the inner cover 43. The shaped top cover 44, the outer cover 45 and the inner cover 43 are sequentially arranged on the enclosure 42 from outside to inside, and are riveted to the enclosure 42 together with a first screw rod 46. The connection arms 452 of the outer cover 45 are further riveted to the enclosure 42 with a second screw rod 47.

The staple driving mechanism 50 is assembled to a head portion at a front end of the main body 40, and includes a pressing member 51 and a complex staple driver 52. The pressing member 51 is arranged between the inner cover 43 and the outer cover 45 for pressing a lower edge against a workpiece, and is provided with a first opening 511 corresponding to the first vertical slots 432 and the third vertical slots 451. The complex staple driver 52 includes a driving plate 522 and a bending plate 523, which are respectively provided with a second opening 521 corresponding to the second vertical slot 433 on the inner cover 43.

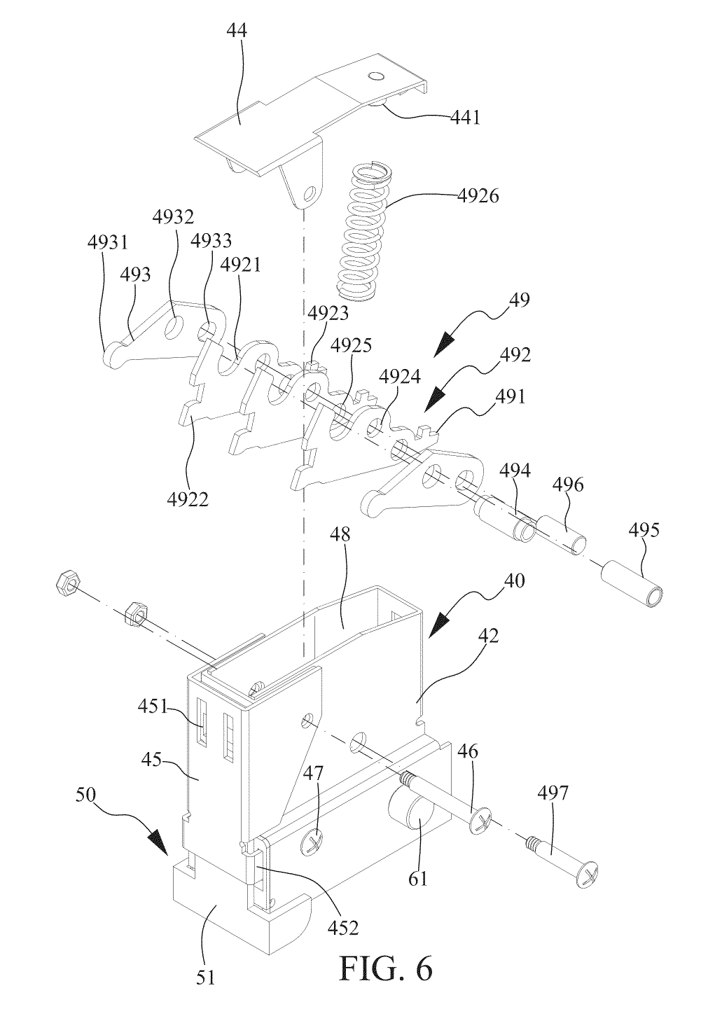

Please refer to FIG. 6. The case 41 defines an operation room 48 therein. A linkage system 49 is arranged in the operation room 48 and pivotally connected to the case 41. The linkage system 49 includes a follower unit 492 consisting of three shape-identical follower links 491, and two driving links 493 separately located at two outer sides of the follower unit 492. Each of the driving links 493 includes a nose portion 4931 projected from a front end thereof, and is provided within a middle section with a first pivot hole 4932 and a second pivot hole 4933. The follower unit 492 is provided on an upper edge with a notch 4921, at a lower front end with a forward projected portion 4922, at a rear end with an upward raised portion 4923, and within a middle section with a third pivot hole 4924 and a fourth pivot hole 4925.

A shouldered pin bush 494 is extended through the first pivot holes 4932 of the two driving links 493 and the notch 4921 of the follower unit 492. The first screw rod 46 is axially extended through the shouldered pin bush 494 to thereby fixedly hold the driving links 493 to the enclosure 42. Meanwhile, the notch 4921 of the follower unit 492 is indirectly abutted on the first screw rod 46 via the pin bush 494. Further, a bare shaft 495 is extended through the second pivot holes 4933 on the driving links 493 and the third pivot hole 4924 on the follower unit 492, such that the driving links 493 and the follower unit 492 are pivotally turnable relative to one another about the bare shaft 495. Moreover, a pin bush 496 is extended through the fourth pivot hole 4925 of the follower unit 492. A third screw rod 497 is axially extended through the pin bush 496, so that the follower unit 492 is pivotally connected to the enclosure 42 by the third screw rod 497.

A compression spring 4926 has an end fitted around the raised portion 4923 of the follower unit 492 and another end extending toward the top cover 44 to fit around a flat pin 441 on an underside of the top cover 44. The nose portions 4931 on the two driving links 493 are separately extended through the two first vertical slots 432 on the inner cover 43, and then together extended through the first opening 511 on the pressing member 51, and further separately extended into the two third vertical slots 451 on the outer cover 45, so that the driving links 493 are engaged with the inner cover 43, the pressing member 51 and the outer cover 45. The forward projected portion 4922 of the follower unit 492 is extended through the second openings 521 on the complex staple driver 52 and further slightly extended into the second vertical slot 433 on the inner cover 43, so that the follower unit 492 is engaged with the complex staple driver 52.

Please refer to FIG. 7. The pusher and magazine assembly 60 is arranged in a lower portion of the operation room 48 to locate at a bottom of the main body 40 and is riveted to the enclosure 42 with a shaft pin 61, so that the pusher and magazine assembly 60 and the main body 40 together define a staple room 62 for receiving the coil staple unit 70 therein. The pusher and magazine assembly 60 includes a magazine 63 and a movable pusher mechanism 64 mounted in the magazine 63. The magazine 63 includes a base board 631, a push block 632 and a bottom cover 633. The base board 631 and the push block 632 are connected to each other and are screwed to the bottom cover 633 together. The base board 631 has a vertically upward extended projection 634, on which a round-sectioned passage 635 is formed to horizontally axially extend through the projection 634. The pusher mechanism 64 includes a push rod 641, which has a front end formed into a beveled surface 642 and is extended through a push plate 643. A locking pin 644 is inserted into the push plate 643 and the push rod 641 to lock them to each other. A staple-pushing spring 645 is fitted around another end of the push rod 641. The portion of the push rod 641 extended through the push plate 643 is further extended into the passage 635. The staple-pushing spring 645 has a rear end pressed against the push block 632, so as to bring the push plate 643 and the push rod 641 to move between the base board 631 and the push block 632 in a reciprocating motion.

A guide unit 65 is further welded to the bottom cover 633 to locate above the upward extended projection 634. The guide unit 65 includes a locating member 651, a spring plate 652 and a guide plate 653, which are sequentially riveted together. The locating member 651 is provided on one side opposite to the spring plate 652 with two laterally spaced and forward extended arms 654. The spring plate 652 has a first extended portion 655 for extending into a space below the locating member 651. The guide plate 653 has two second extended portions 656 for extending into a space below the spring plate 652. When the locating member 652, the spring plate 652 and the guide plate 653 are riveted together, the first extended portion 655 and the second extended portions 656 are located between the two extended arms 654, while the first extended portion 655 is located between the two second extended portions 656.

FIGS. 8A to 8D show how the coil stapler of the present invention operates. The coil staple unit 70 includes a plurality of bar-shaped staples 71, which are parallelly arranged and continuously connected to form a web for winding into a coil. To use the coil stapler of the present invention, first mount the coil staple unit 70 in the staple room 62 by supporting the coil staple unit 70 on the shaft pin 61. And then, pull out and extend a front end of the coil staple unit 70 through an upper space in the bottom cover 633 for the bar-shaped staples 71 thereof to locate between the pusher mechanism 64 and the guide unit 65 while a first one of the bar-shaped staples 71 is located immediately below the complex staple driver 52.

When the main body 40 is downward pushed by a user, the pressing member 51 engaged with the driving links 493 moves upward relative to the downward moved main body 40. When the pressing member 51 moves upward, it brings the nose portions 4931 of the driving links 493 to move upward at the same time, causing the driving links 493 to pivotally turn about the shouldered pin bush 494. As a result, rear ends of the driving links 493 and the bare shaft 495 extended through the second pivot holes 4933 near the rear ends are moved downward. On the other hand, the downward movement of the bare shaft 495, which is also extended through the third pivot hole 4924 on the follower unit 492, causes the follower unit 492 to pivotally turn about the third screw rod 497, bringing the forward projected portion 4922 at the lower front end of the follower unit 492 to move downward and the raised portion 4923 at the rear end of the follower unit 492 to move upward. The upward moved raised portion 4923 compresses the compression spring 4926, which is fitted around the raised portion 4923 and located between the follower unit 492 and the top cover 44; and the downward movement of the forward projected portion 4922, which is extended through the second openings 521 on the complex staple driver 52, brings the complex staple driver 52 to move downward. As a result, the first bar-shaped staple 71 of the coil staple unit 70 located immediately below the complex staple driver 52 is bent by the bending plate 523 and the bent staple is driven by the driving plate 522 into a workpiece (not shown) at the same time.

The first bar-shaped staple 71 on the coil staple unit 70 is located below the bending plate 523 of the complex staple driver 52 and above the upward extended projection 634 of the base board 631. When the bending plate 523 is moved downward, two opposite ends of the first bar-shaped staple 71 are downward bent between the upward extended projection 634 and the bending plate 523 into an inverted-U shape. Meanwhile, the downward moved driving plate 522 of the complex staple driver 52 comes into contact with the beveled surface 642 at the front end of the push rod 641, forcing the latter to move backward and thereby compresses the staple-pushing spring 645 that is located between the push plate 643 and the push block 632. When the complex staple driver 52 completes one driving movement, the main body 40 is released and elastically returns to its original position. At this point, the complex staple driver 52 is also moved upward to separate from the push rod 641, and the staple-pushing spring 645 is released from the compressed state to thereby elastically move the push plate 643 and the push rod 641 forward, which in turn move a subsequent second staple 71 at the front end of the coil staple unit 70 to the position immediately below the complex staple driver 52.

When the main body 40 is pushed downward again for another stapling operation, the complex staple driver 52 is moved downward again. At this point, the driving plate 522 drives the staple 71, which is located below the complex staple driver 52 and has been bent by the bending plate 523, into the workpiece. Then, the pusher mechanism 64 repeats the same movement as before to push a subsequent bar-shaped staple 71 to the position below the driving plate 522, and the coil stapler is ready for another stapling operation. With these arrangements, the main body 40 of the coil stapler of the present invention can be repeatedly downward pushed to drive the staples 71 into predetermined positions.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A hand-operated coil stapler, comprising:
a main body including a case, in which an operation room is defined; and a linkage system being arranged in the operation room and pivotally connected to the case;
a staple driving mechanism being assembled to a head portion at a front end of the main body, and including a pressing member and a complex staple driver; the pressing member being movably assembled to an outer side of the case to engage with the linkage system; and the complex staple driver also being engaged with the linkage system and including a driving plate and a bending plate;
a pusher and magazine assembly being connected to a bottom of the main body, so that the pusher and magazine assembly and the main body together define a staple room in between them; the pusher and magazine assembly including a magazine and a movable pusher mechanism mounted in the magazine; and the pusher mechanism including a push rod, a push plate fixedly connected to a front end of the push rod, and a staple-pushing spring fitted around another end of the push rod; and
a coil staple unit including a plurality of bar-shaped staples, which are parallelly arranged and continuously connected to form a web for winding into a coil; and the coil staple unit being mounted in the staple room with a front end thereof located below the complex staple driver;
wherein when the main body is downward pushed relative to the pressing member, the linkage system brings the complex staple driver to move downward to thereby bend a first one of the bar-shaped staples at the front end of the coil staple unit and drive the bent staple downward at the same time; meanwhile, the downward moved complex staple driver comes into contact with the push rod, forcing the same backward and thereby compressing the staple-pushing spring; and when the main body is released, the complex staple driver is moved upward to separate from the push rod, and the staple-pushing spring is released from the compressed state to thereby elastically push the push plate and the push rod forward, which in turn move a subsequent staple on the coil staple unit to the position immediately below the complex staple driver for use in a next stapling operation.

2. The hand-operated coil stapler as claimed in claim 1, wherein the case includes an enclosure, a shaped top cover riveted to a top opening of the enclosure, and an inner cover riveted to a front opening of the enclosure; the inner cover being provided with two laterally spaced first vertical slots, a second vertical slot located below the first vertical slots, and two laterally spaced insertion slots; the pressing member being provided with a first opening at a position corresponding to the first vertical slots on the inner cover; and the complex staple driver being provided with second openings at a position corresponding to the second vertical slot on the inner cover, and being engaged with the linkage system via the second openings.

3. The hand-operated coil stapler as claimed in claim 2, wherein the main body further includes an outer cover located at an outer side of the inner cover; the outer cover including two laterally spaced connection arms correspondingly inserted into the two insertion slots on the inner cover, so that the outer cover and the inner cover are together riveted to the enclosure with a first screw rod and the connection arms of the outer cover are further riveted to the enclosure with a second screw rod; the pressing member being located between the outer cover and the inner cover; the outer cover being provided with two laterally spaced third vertical slots corresponding to the first vertical slots; and the outer cover being engaged with the linkage system via the third vertical slots, the first opening on the pressing member and the first vertical slots on the inner cover.

4. The hand-operated coil stapler as claimed in claim 3, wherein the linkage system includes a follower unit, a compression spring fitted on the follower unit, and two driving links located at two outer sides of the follower unit;
each of the driving links having a nose portion projected from a front end thereof and being provided with a first pivot hole and a second pivot hole; the nose portions sequentially engaging with the first vertical slots, the first opening and the third vertical slots; and the first screw rod being extended through the first pivot hole; and
the follower unit being provided on an upper edge with a notch corresponding to the first screw rod, at a lower front end with a forward projected portion corresponding to the second openings and the second vertical slot, at a rear end with an upward raised portion, on which an end of the compression spring is fitted, and within a middle section with a third pivot hole and a fourth pivot hole; a bare shaft being extended through the second pivot holes on the driving links and the third pivot hole on the follower unit, such that the driving links and the follower unit are pivotally turnable relative to one another about the bare shaft; and a third screw rod being extended through the fourth pivot hole, so that the follower unit is pivotally connected to the enclosure.

5. The hand-operated coil stapler as claimed in claim 4, wherein the shaped top cover is provided with a pin, on which another end of the compression spring is fitted.

6. The hand-operated coil stapler as claimed in claim 1, wherein the magazine includes a base board, a push block and a bottom cover; the bottom cover being riveted to the case with a shaft pin; the base board and the push block being connected to each other and screwed to the bottom cover together; and the base board being provided with a vertically upward extended projection having a horizontally axially extended passage for the push rod to extend therethrough.

7. The hand-operated coil stapler as claimed in claim 6, wherein the pusher and magazine assembly further includes a guide unit welded to the bottom cover to locate above the upward extended projection of the base board; and the guide unit including a locating member, a spring plate and a guide plate, which are sequentially riveted together.

8. The hand-operated coil stapler as claimed in claim 7, wherein the locating member is provided on one side opposite to the spring plate with two laterally spaced and forward extended arms, the spring plate having a first extended portion, and the guide plate having two second extended portions; whereby when the locating member, the spring plate and the guide plate are sequentially riveted together, the first extended portion is located between the two second extended portions while the first extended portion and the second extended portions are together located between the two extended arms of the locating member.

9. The hand-operated coil stapler as claimed in claim 6, wherein an end of the push rod that is extended through the passage on the upward extended projection of the base board is formed into a beveled surface.

10. The hand-operated coil stapler as claimed in claim 1, wherein the coil staple unit mounted in the staple room is supported on a shaft pin provided on the case.
